(19) United States
(12) Patent Application Publication
(10) Pub. No.: US 2008/0267634 A1
(43) Pub. Date: Oct. 30, 2008

(54) 9b10b Code for Passive Optical Networks

(75) Inventor: Frank J. EFFENBERGER, Freehold, NJ (US)

Correspondence Address: CONLEY ROSE, P.C., 5601 GRANITE PARKWAY, SUITE 750, PLANO, TX, 75024, US

(73) Assignee: FUTUREWEI TECHNOLOGIES, INC., Plano, TX (US)

(21) Appl. No.: 12/038,698

(22) Filed: Feb. 27, 2008

Related U.S. Application Data
(60) Provisional application No. 60/915,052, filed on Apr. 30, 2007.

(51) Int. Cl. H04B 10/00

(52) U.S. Cl. 398/128

(57) ABSTRACT

An apparatus comprising at least one processor configured to implement a method comprising receiving an incoming data stream, converting the incoming data stream into an outgoing data stream comprising a plurality of ten-bit codepoints each comprising nine data bits, and transmitting the outgoing data stream. Also disclosed is an apparatus comprising a nine-bit data block/ten-bit codepoint converter, an optical receiver coupled to the nine-bit data block/ten-bit codepoint converter, and an optical transmitter coupled to the nine-bit data block/ten-bit codepoint converter.

### CROSS-REFERENCE TO RELATED APPLICATIONS

The present application claims priority to U.S. Provisional Patent Application Ser. No. 60/915,052 filed Apr. 30, 2007 by Effenberger and entitled, “9b10b Code for PON,” which is incorporated herein by reference as if reproduced in its entirety.

### STATEMENT REGARDING FEDERALLY SPONSORED RESEARCH OR DEVELOPMENT

Not applicable

### REFERENCE TO A MICROFICHE APPENDIX

Not applicable.

### BACKGROUND

A passive optical network (PON) is one system for providing network access over “the last mile.” The PON is a point to multi-point network comprised of an optical line terminal (OLT) at the central office, an optical distribution network (ODN), and a plurality of optical network terminals (ONTs) at the customer premises. The ODN comprises optical fibers, couplers, splitters, distributors, filters, and other passive optical devices, which connect the OLT to the ONTs. The OLT broadcasts downstream data to the ONUs and receives upstream data from the ONUs in the form of optical burst signals. These optical burst signals comprise a series of bits (ones and zeros) represented by high and low energies, which can be detected by receivers in the OLT and ONTs.

The arrangement of the bits in the optical burst signal can affect the optical receivers. For example, a series of sequential identical bits may gradually change the decision threshold adjustment, which is the energy baseline that the receivers use to distinguish between the one bits and the zero bits. They can also affect other aspects of the receivers, such as clock timing recovery. Thus, it is generally undesirable to transmit the data without any assurances that the data will contain an adequate mixture of one bits and zero bits. As such, the eight bit-ten bit (8b10b) coding scheme has been used to ensure that the optical bursts contain an adequate mixture of one bits and zero bits. The 8b10b code maps eight bits of user data into ten-bit long codepoints that contain an adequate mixture of one and zero bits. Unfortunately, the 8b10b coding scheme adds two additional bits of overhead to every eight bits of user data, which increases the bandwidth required for transmitting the user data by about twenty-five percent.

### SUMMARY

In one embodiment, the disclosure includes an apparatus comprising at least one processor configured to implement a method comprising receiving an incoming data stream, converting the incoming data stream into an outgoing data stream comprising a plurality of ten-bit codepoints each comprising nine data bits, and transmitting the outgoing data stream.

In another embodiment, the disclosure includes an apparatus comprising a nine-bit data block/ten-bit codepoint converter, an optical receiver coupled to the nine-bit data block/ten-bit codepoint converter, and an optical transmitter coupled to the nine-bit data block/ten-bit codepoint converter.

In yet another embodiment, the disclosure includes a method comprising identifying a group comprising a plurality of codepoints each having a common length, excluding from the group any codepoints with a bit disparity absolute value greater than a first threshold, excluding from the group any codepoints with a consecutive number of identical bits greater than a second threshold, and defining a special codepoint within the group that has a hamming distance greater than a third threshold from any other codepoint.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a PON.

FIG. 2 is a table of an embodiment of a codepoint distribution.

FIG. 3 is a table of an embodiment of a plurality of excluded codepoints.

FIGS. 4A-4C are a table of an embodiment of a special codepoint and similar codepoints.

FIGS. 5A-5Q are a table of an embodiment of a 9b10b code.

FIG. 6 is a flowchart of an embodiment of a 9b10b coding method.

FIG. 7 is a schematic diagram of one embodiment of a general-purpose computer system.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein is a 9b10b code that may be implemented in PON systems. The 9b10b code may map nine-bit data blocks into ten-bit codepoints that may be transmitted down the optical fibers and that may conform to the transmission standards and the physical layer requirements of the PON. The codepoints may be substantially direct current (DC) balanced in that the codepoints may comprise about the same number of one bits and zero bits. Additionally, the codepoints may comprise at most five consecutive identical bits, which results in a maximum run length of ten consecutive identical bits in the transmitted data stream. Furthermore, the codepoints may comprise one or more parity bits that may be used for forward error correction (FEC) without significantly increasing the bandwidth requirements in the PON systems.

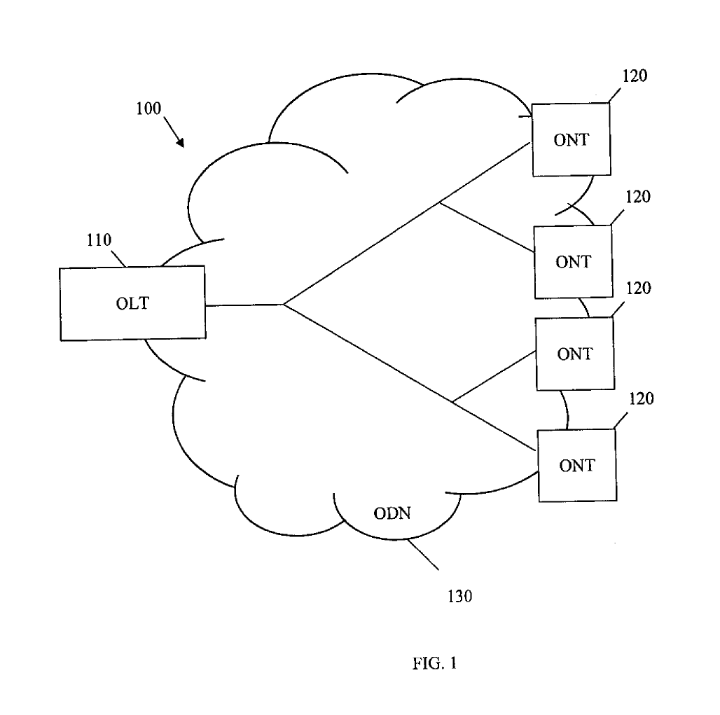

FIG. 1 illustrates one embodiment of a PON 100. The PON 100 may comprise an OLT 110, a plurality of ONTs 120, and an ODN 130. The PON 100 may be a communications network that does not require any active components to distribute data between the OLT 110 and the ONTs 120. Instead, the PON 100 may use the passive optical components in the ODN 130 to distribute data between the OLT 110 and the ONTs 120. Examples of suitable PONs 100 may include the asynchronous transfer mode PON (APON) and the broadband PON (BPON) defined by the ITU-T G.983 standard, the Gigabit PON (GPON) defined by the ITU-T G.984 standard, the Ethernet PON (EPON) defined by the IEEE 802.3ah standard, and the wavelength division multiplexing PON (WDM-PON), all of which are incorporated by reference as if reproduced in their entirety.

One component of the PON 100 may be the OLT 110. The OLT 110 may be any device that is configured to communicate with the ONTs 120 and another network (not shown). Specifically, the OLT 110 may act as an intermediary between the other network and the ONTs 120. For instance, the OLT 110 may forward data received from the network to the ONTs 120, and forward data received from the ONTs 120 onto the other network. Although the specific configuration of the OLT 110 may vary depending on the type of PON 100, in an embodiment, the OLT 110 may comprise a transmitter and a receiver, as explained in detail below. When the other network is using a protocol, such as Ethernet, synchronous optical networking (SONET), or synchronous digital hierarchy (SDH), that is different from the communications protocol used in the PON 100, the OLT 110 may comprise a converter that converts the other network's data into the PON's protocol. The converter may also convert the PON's data into the other network's protocol. The OLT 110 described herein is typically located at a central location, such as a central office, but may be located at other locations as well.

Another component of the PON 100 may be the ONTs 120. The ONTs 120 may be any devices that are configured to communicate with the OLT 110 and a customer or user (not shown). Specifically, the ONTs 120 may act as an intermediary between the OLT 110 and the customer. For instance, the ONTs 120 may forward data received from the OLT 110 to the customer, and forward data received from the customer onto the OLT 110. Although the specific configuration of the ONTs 120 may vary depending on the type of PON 100, in an embodiment, the ONTs 120 may comprise an optical transmitter configured to send optical signals to the OLT 110. Additionally, the ONTs 120 may comprise an optical receiver configured to receive optical signals from the OLT 110 and a converter that converts the optical signal into electrical signals for the customer, such as signals in the asynchronous transfer mode (ATM) or Ethernet protocol. The ONTs 120 may also comprise a second transmitter and/or receiver that may send and/or receive the electrical signals to/from a customer device. In some embodiments, ONTs 120 and optical network units (ONUs) are similar, and thus the terms are used interchangeably herein. The ONTs 120 are typically located at distributed locations, such as the customer premises, but may be located at other locations as well.

Another component of the PON 100 may be the ODN 130. The ODN 130 is a data distribution system that may comprise optical fiber cables, couplers, splitters, distributors, and/or other equipment. In an embodiment, the optical fiber cables, couplers, splitters, distributors, and/or other equipment are passive optical components. Specifically, the optical fiber cables, couplers, splitters, distributors, and/or other equipment may be components that do not require any power to distribute data signals between the OLT 110 and the ONTs 120. The ODN 130 typically extends from the OLT 110 to the ONTs 120 in a branching configuration as shown in FIG. 1, but may be configured in any of a plurality of alternative configurations.

The OLT 110 and ONTs 120 may be configured to convert nine-bit data blocks into ten-bit codepoints using a 9b10b coding scheme, and transmit the codepoints across the PON 100. Each data block may be associated with one value from a set of 512 values of user data. For example, the possible values of data blocks may be associated with their equivalent decimal values from zero to 511. Consequently, each transmitted codepoint corresponding to one of the data blocks may also be associated with the values from zero to 511. The OLT 110 and ONTs 120 may be configured to receive the codepoints and convert each codepoint back to the corresponding data block.

In an embodiment, the OLT 110 and ONTs 120 may comprise a media access logic (MAC) device, such as a nine-bit data block/ten-bit codepoint converter, which may convert the data blocks into the codepoints, and vice-versa. The MAC logic device may be coupled to an optical transmitter, and may send the codepoints to the optical transmitter, which may transmit the codepoints across the PON 100. The OLT 110 and ONTs 120 may also comprise an optical receiver that may receive the transmitted codepoints by detecting the optical burst signals. The optical receiver may also be coupled to the MAC device, and may send the codepoints to the MAC logic device, which may convert the codepoints back to the corresponding data blocks.

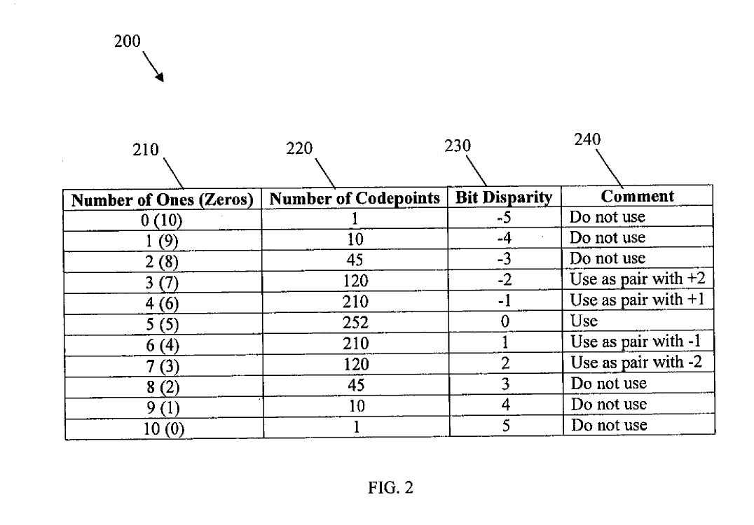

FIG. 2 shows a table 200 that illustrates an embodiment of the codepoints that may be transmitted in the PON 100. Each codepoint may comprise a pattern of ten bits that may include zero bits, one bits, or both. The codepoints may be grouped into eleven subsets of codepoints, where each subset represents a group of codepoints that may comprise a specific number of one bits and zero bits as indicated in column 210. The properties of each of the eleven subsets are shown in the rows of the table 200. Specifically, the number of codepoints in each subset is shown in column 220, and the bit disparity corresponding to each subset is shown in column 230. The bit disparity may be equal to the difference between the number of one bits and five. Specifically, the bit disparity may be positive when the number of one bits exceeds five, and negative when the number of one bits is less than five. The bit disparity may be equal to zero when there are five one bits and five zero bits.

The first five subsets shown in table 200 correspond to codepoints with negative bit disparity. The first subset with negative bit disparity may comprise one codepoint that includes ten zero bits and no one bits. The bit disparity of such a codepoint is equal to negative five, which means that the number of zero bits exceeding five in the codepoint is equal to five. The second subset may comprise ten codepoints each comprising a single one bit and nine zero bits, where each pattern may comprise a different sequence of the single one bit and the nine zero bits. The bit disparity of the ten codepoints in the second subset may be equal to negative four, which indicates that the number of zero bits exceeding five in each of the ten patterns is equal to four. The third subset may comprise 45 codepoints each comprising two one bits and eight zero bits. The bit disparity of the 45 codepoints in the third subset may be equal to negative three. The fourth subset may comprise 120 codepoints each comprising three one bits and seven zero bits, and having a bit disparity equal to negative two. The fifth subset may comprise 210 codepoints each comprising four one bits and six zero bits, and having a bit disparity equal to negative one. On the other hand, the sixth subset may comprise codepoints that have a bit disparity equal to zero, e.g. that comprise five one bits and five zero bits. Moreover, the sixth subset may comprise the largest number of codepoints with respect to the other subsets in the table, which may be equal to 252 codepoints.

The remaining five subsets may correspond to codepoints with positive bit disparity. The codepoints in each of the five remaining subsets may be complementary to the codepoints in the first five subsets. In other words, the codepoints in each of the five remaining subsets may comprise complementary sequences of one bits and zero bits when compared with the codepoints in the first five subsets. As used herein, a complementary codepoint is a codepoint in which the zero bits are replaced by one bits, and vice versa. The codepoints in each of the five remaining subsets may have positive disparities that may be equal in absolute values to those of the codepoints in the first five subsets. Specifically, the seventh subset may comprise 210 codepoints that are complementary to the 210 codepoints in the fifth subset, and that have a bit disparity equal to one instead of negative one. The eighth subset may comprise 120 codepoints that are complementary to the 120 codepoints in the fourth subset, and that have a bit disparity equal to two instead of negative two. Similarly, the ninth, tenth, and eleventh subsets may comprise 45, ten, and one codepoint(s) that are complementary to those in the third, second, and first subsets, and that have a bit disparity equal to three instead of negative three, four instead of negative four, and five instead of negative five, respectively.

The bit disparity of a codepoint may also reflect the amount of average energy, or DC balance, in the transmitted optical burst signals. The DC balance may be determined by the number of detected high and low energies of the optical burst signals corresponding to the one bits and zero bit in the codepoint. For instance, a codepoint with a bit disparity equal to zero, may comprise five one bits and five zero bits that may be received by detecting an equal amount of high and low energies of the optical burst signals. Such codepoint may be DC balanced where the average energy in the detected optical burst signals may be substantially close to the threshold energy level used by the detector to distinguish between the high and low optical burst energies. As a result, the detector may distinguish between the optical burst signals without or with negligible tuning or adjustment of the threshold to receive the codepoint. Moreover, when a plurality of codepoints having a bit disparity equal to about zero are being transmitted, the average energy in the detected optical burst signals may remain substantially close to the threshold. The detector may then distinguish between the high and low energies, or between the one bits and the zero bits, with less frequent threshold decision adjustment than may be required in the case of codepoints with higher absolute bit disparity values. The codepoints with bit disparity values closer to zero may require less processing time for detection, and are said to be more DC balanced.

As indicated in column 240, the codepoints may comprise some of the 252 DC balanced codepoints, e.g. those with zero bit disparity. The codepoints may also comprise additional codepoints that have sufficient DC balance to reduce the detector time requirement for the threshold decision adjustment and provide enough codepoints to map the 512 data block values. The additional codepoints may be selected based on a bit disparity threshold. For example, the additional codepoints may be selected from the 210 pairs of complementary codepoints of the fifth and seventh subsets with disparities equal to negative one and one, respectively and from the 120 pairs of complementary codepoints of the fourth and eighth subsets with disparities equal to negative two and two, respectively.

The codepoints with positive bit disparity can be equivalent of their complement. With such equivalency, the codepoints can be selected based on the running bit disparity of the data stream. Specifically, either a codepoint with a positive bit disparity or its complementary codepoint with the negative bit disparity may be selected for transmission to maintain a running bit disparity of the data stream between negative two and two. The running bit disparity may be updated by adding the bit disparity of the next codepoint to the running bit disparity. For instance, when the running bit disparity is equal to negative two, the next codepoint may have a bit disparity equal to two, which results in an updated running bit disparity equal to zero. Hence, the received string of codepoints at the detector may be DC balanced. The next transmitted codepoint may alternatively have a bit disparity equal to one or zero, resulting in a less but sufficiently DC balanced string of received codepoints. To maintain the running bit disparity equal to about zero and bounded between negative two and two, a codepoint with zero or positive bit disparity may be transmitted when the running bit disparity is negative, and a codepoint with zero or negative bit disparity may be transmitted when the running bit disparity is positive. Thus, the data block may be mapped interchangeably into one of the two complementary codepoints depending on the value of the running bit disparity.

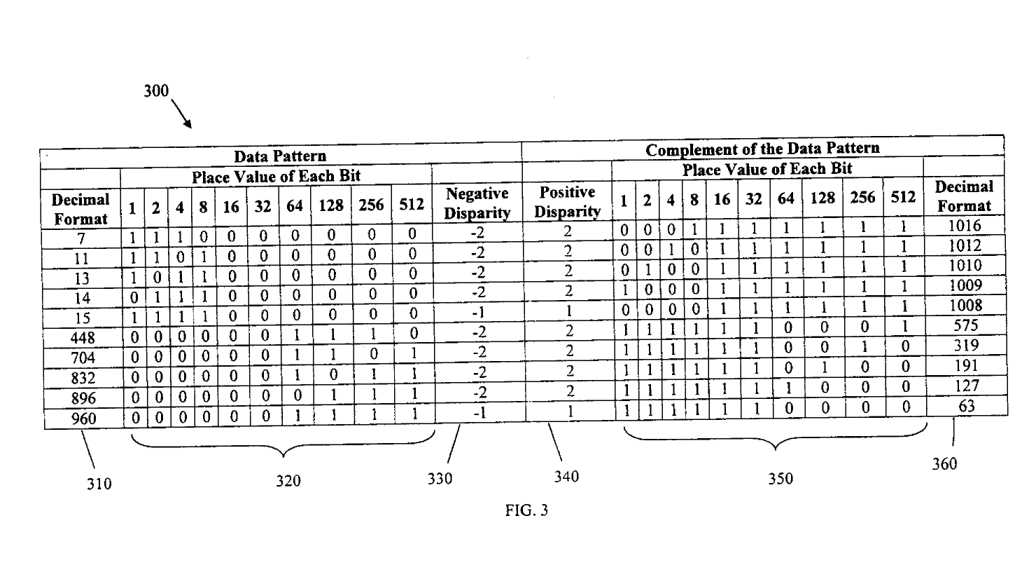

FIG. 3 shows a table 300 that illustrates an embodiment of codepoints with bounded bit disparity between negative two and two that may be excluded from the 9b10b code. Specifically, these codepoints are excluded because they contain a quantity of consecutive identical bits that exceeds a predetermined threshold, e.g. five bits. Each pair of the ten excluded pairs, may comprise one codepoint with a positive bit disparity and a complementary codepoint with a negative bit disparity, and is shown in one row in the table 300. The excluded codepoints may comprise one pair from the 210 pairs of complementary codepoints with absolute disparities equal to one, and eight pairs from the 120 pairs of complementary codepoints with absolute disparities equal to two. Column 320 shows the place value of each bit in the codepoint, whereas column 310 shows the decimal value for each codepoint with a negative bit disparity and column 330 shows the corresponding negative bit disparity value. The last three columns 340, 350, and 360 are related to the complementary codepoint, and show the equivalent decimal value for each codepoint with a positive bit disparity, the value of each bit in the pattern, and the corresponding positive bit disparity value, respectively.

In the table 300, the codepoints and the complementary codepoints may each comprise a number of consecutive and similar bits, referred to as a run-length, which is greater than a threshold value, e.g. five at either of the two edges of the pattern. When a string of transmitted codepoints with bounded disparities between negative two and two may include any of the codepoints in table 300, some of the adjacent codepoints in the string may have a run-length greater than ten. By excluding the codepoints with run-lengths greater than five, the run-length in the string of transmitted codepoints may be limited to ten at most to restrict the number of transitions between the detected high and low optical burst energies. Restricting the number of transitions in the optical burst energies may be useful to reduce the processing time requirement for the clock timing recovery in the detector for receiving the codepoints. After excluding the ten pairs of complementary codepoints with run-lengths greater than five, the available or codepoints that may be used to map the 512 data block values may comprise some of the 252 DC balanced codepoints plus 208 pairs of complementary codepoints with absolute disparities equal to one and 112 pairs of complementary codepoints with absolute disparities equal to two.

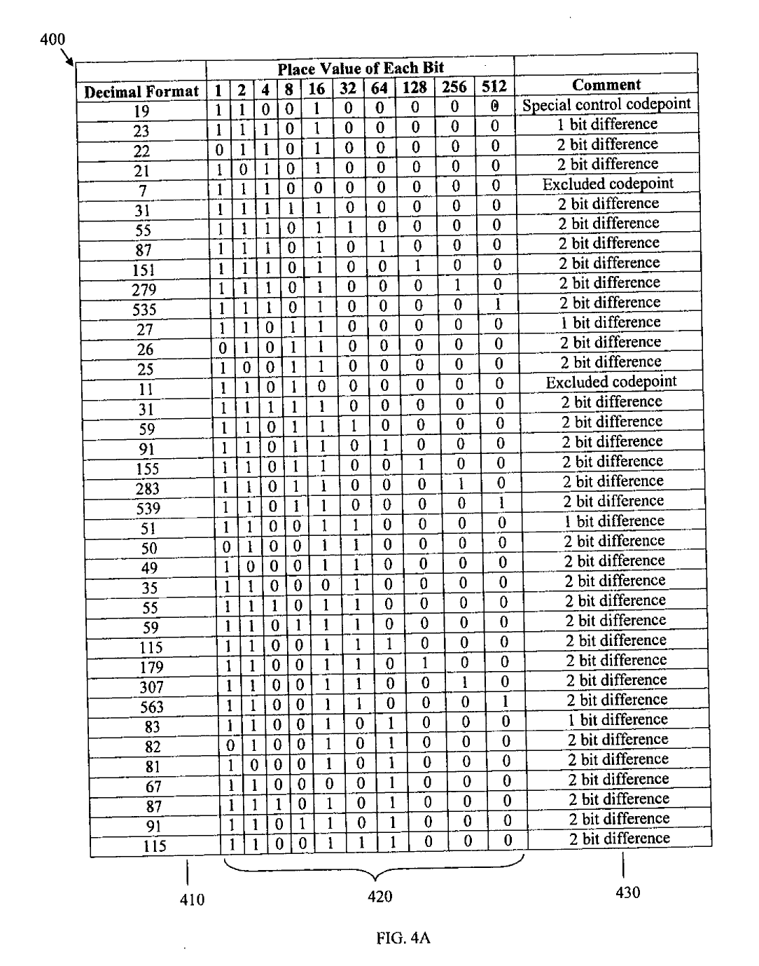

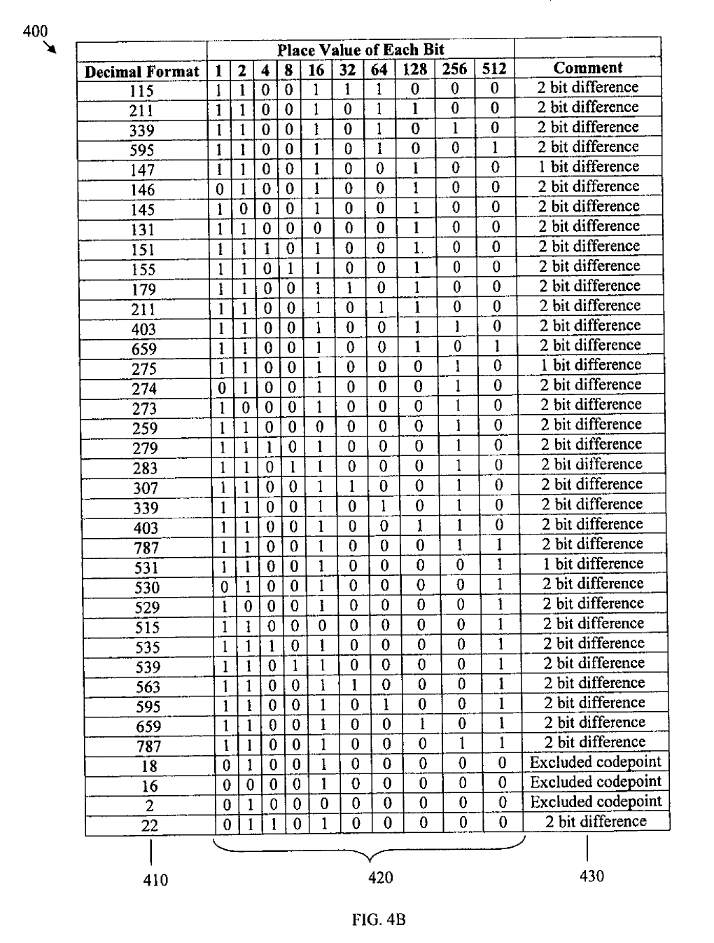

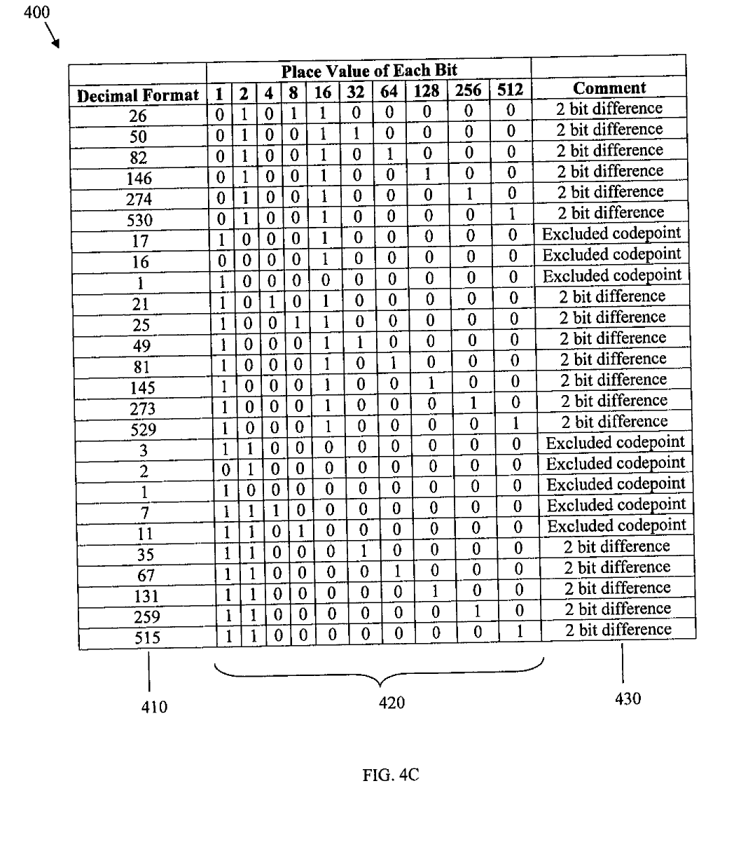

FIGS. 4A-4C show a table 400 that illustrates an embodiment of a special codepoint as well as similar codepoints. The special codepoint may be used as a flag or a delimiter indicating, for example, a start of a frame in a string of transmitted codepoints. Similar to the other codepoints, the special codepoint may comprise a pair of complementary codepoints, which are selected depending on the value of the running bit disparity in the string of transmitted codepoints. The special codepoint and its complement may be chosen from the 112 pairs of codepoints and complements with absolute bit disparity values equal to two. Preferably, the special codepoint may comprise as many bits as possible that are different from those used for the user data, where the number of dissimilar bits may be referred to as the hamming distance from the other codepoints. The special codepoints with larger hamming distances are more likely to be detected and distinguished from the other codepoints even when bit errors occur. Specifically, the special codepoints may be chosen from six pairs with the largest hamming distances from the other codepoints among the 112 pairs of codepoints identified above. The choice of the special codepoints may be arbitrary, and one of these special codepoints is shown in the first row of FIG. 4A. Specifically, the chosen special codepoint may have an equivalent decimal value of nineteen.

The additional codepoints shown in the table 400 in the rows following the chosen special codepoint comprise codepoints that may have hamming distances of one or two from the special codepoint, as noted in column 430. The additional codepoints may comprise seven codepoints with hamming distances of one from the special codepoint. The seven codepoints may be part of the 208 pairs of complementary codepoints with absolute bit disparity values equal to one. The additional codepoints may also comprise 40 codepoints with hamming distances of two from the special codepoint. Some of the 40 codepoints may be part of the 252 DC balanced codepoints, while the remaining codepoints may be part of the 112 pairs of complementary codepoints with absolute bit disparity values equal to two. The 7 codepoints and the 40 codepoints with hamming distances of one and two, respectively, may be interpreted to be the special codepoints when multiple bit errors occur. Therefore, the joint 47 codepoints and their complements may be reserved, and thus are not used in the 9b10b code. Some of the codepoints shown in the table 400 with hamming distances of one and two from the special codepoint may be part of the excluded codepoints with absolute bit disparity values greater than two, run-lengths greater than five, or both.

In addition to the special codepoint, some of the data codepoints and some of the 40 reserved codepoints shown in the table 400 may comprise twelve remaining pairs of complementary codepoints (not shown in the table 400). The 12 remaining pairs of complementary codepoints may have hamming distances of one from the data codepoints and may be used as control codepoints.

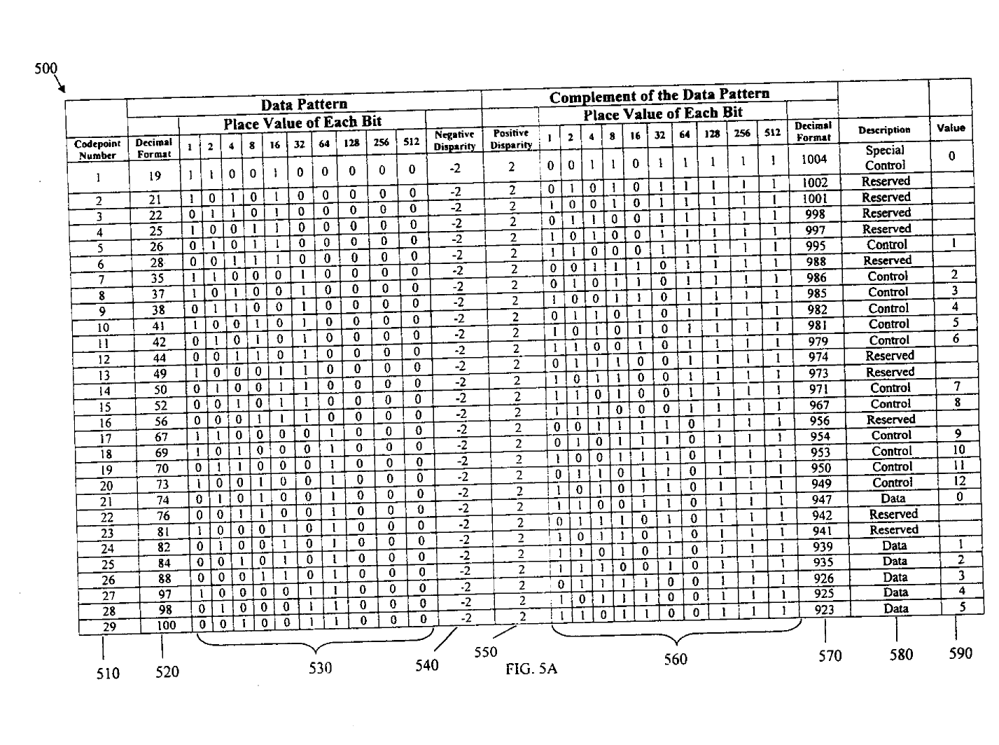

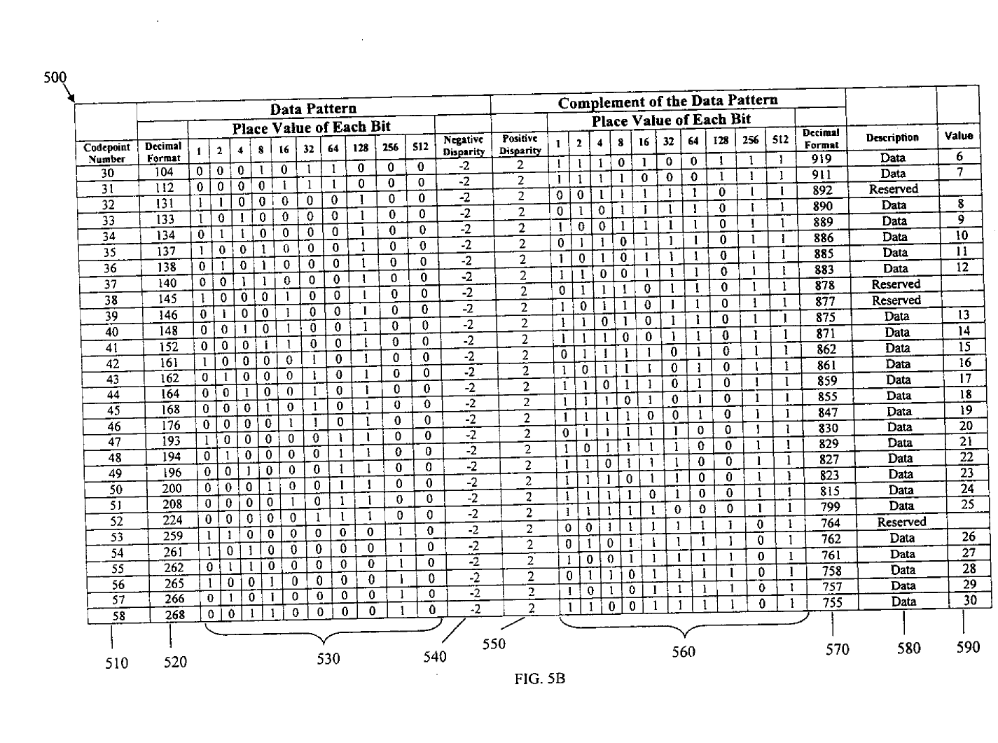

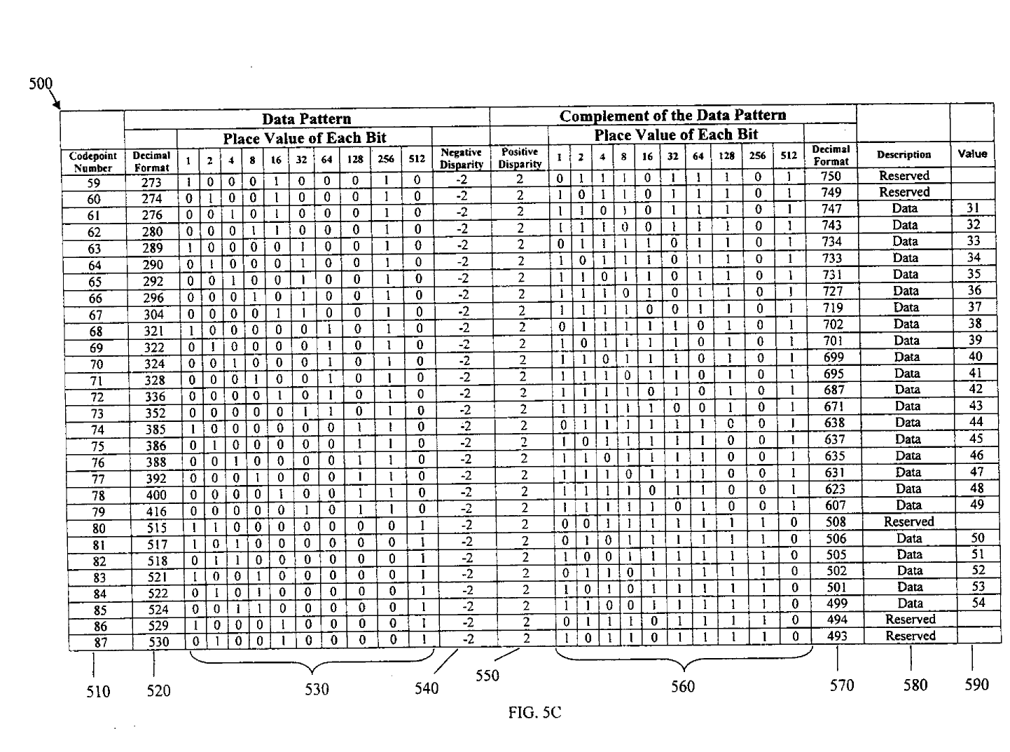

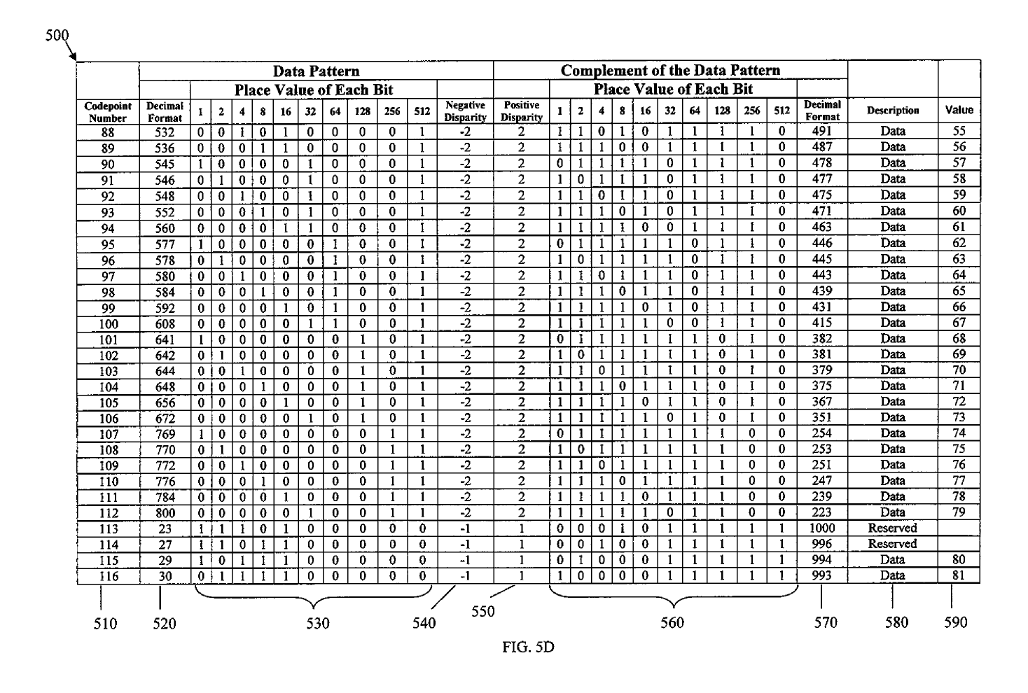

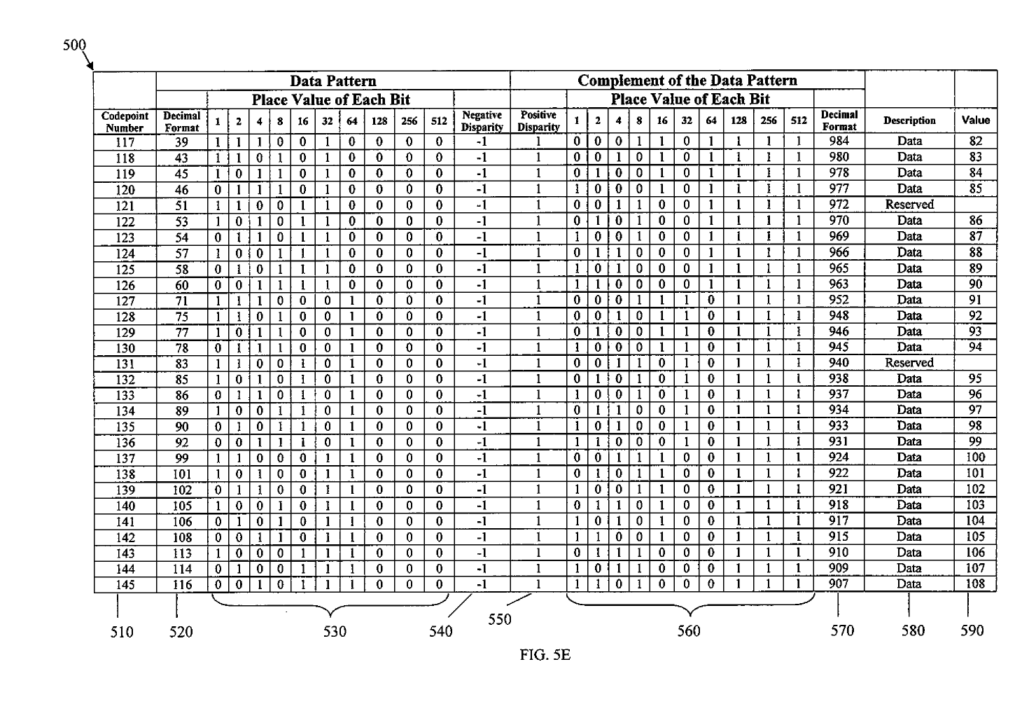

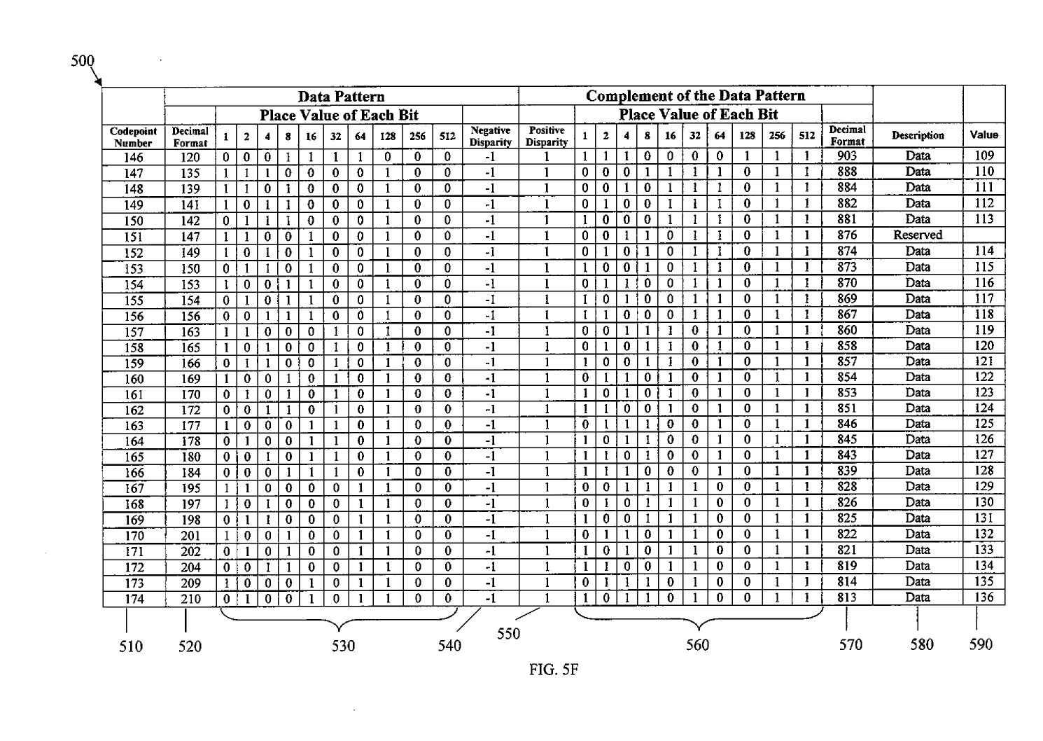

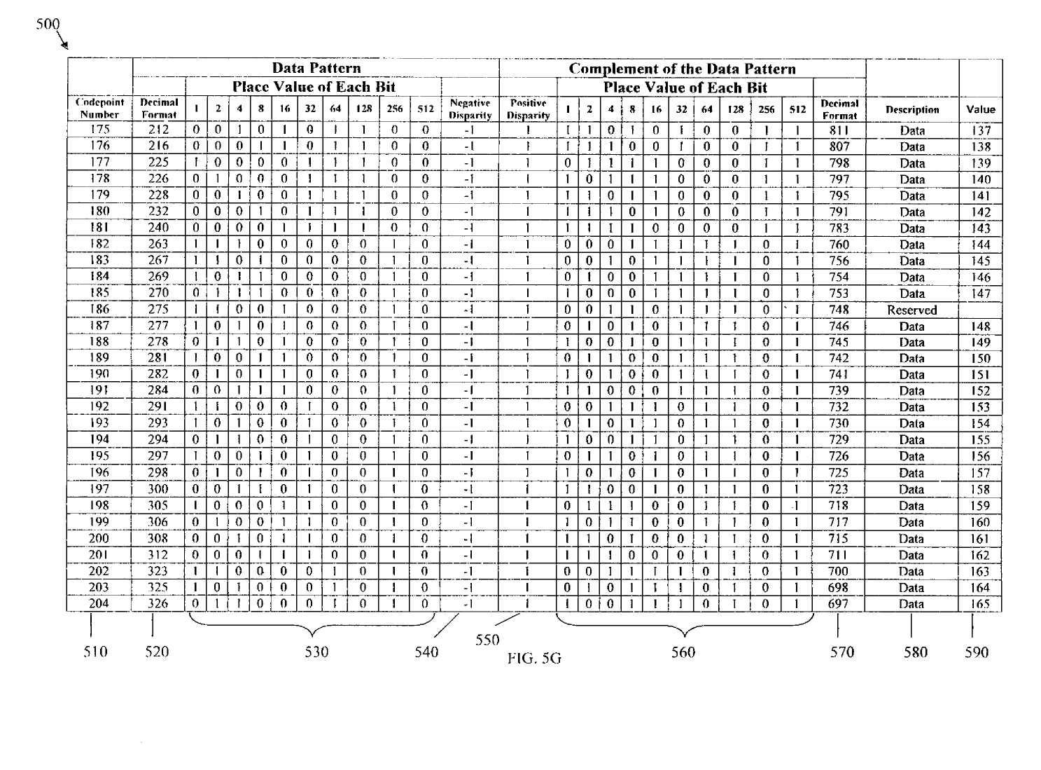

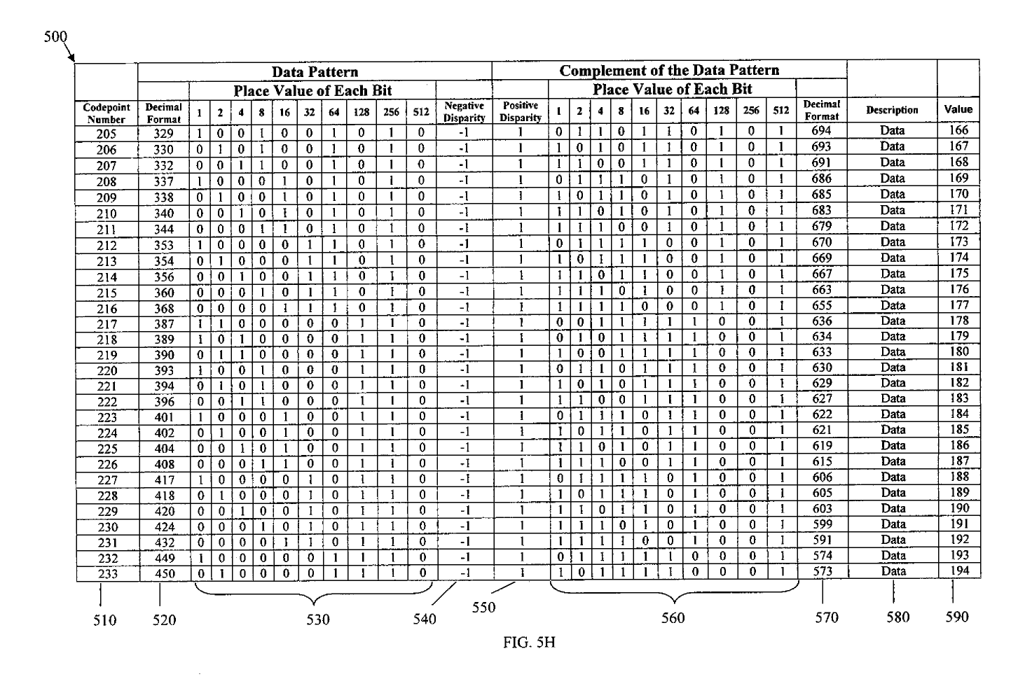

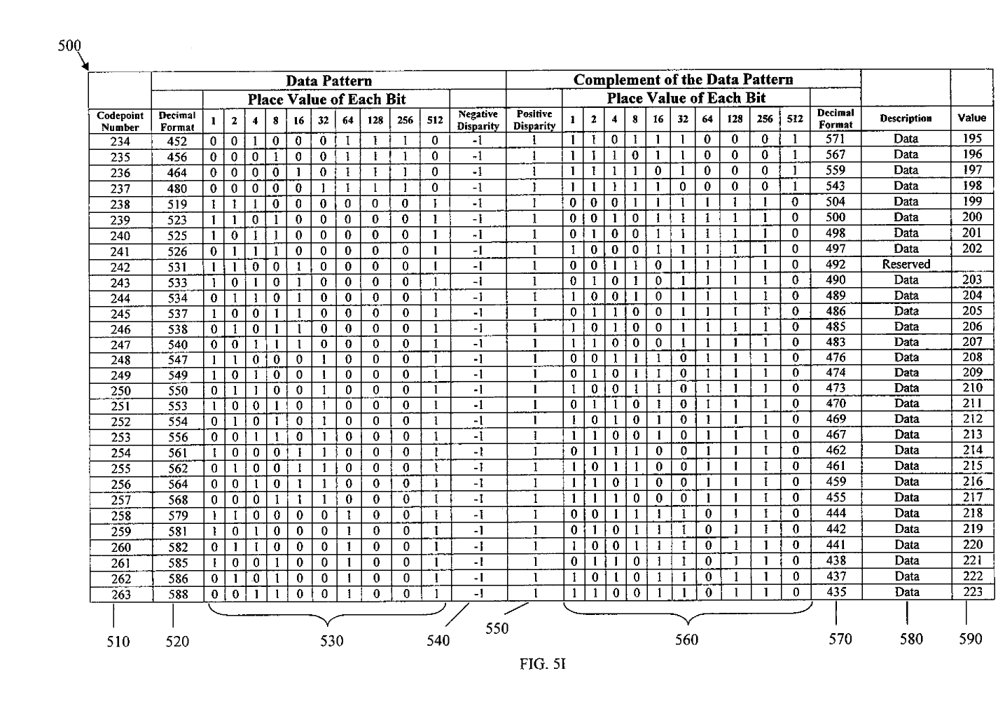

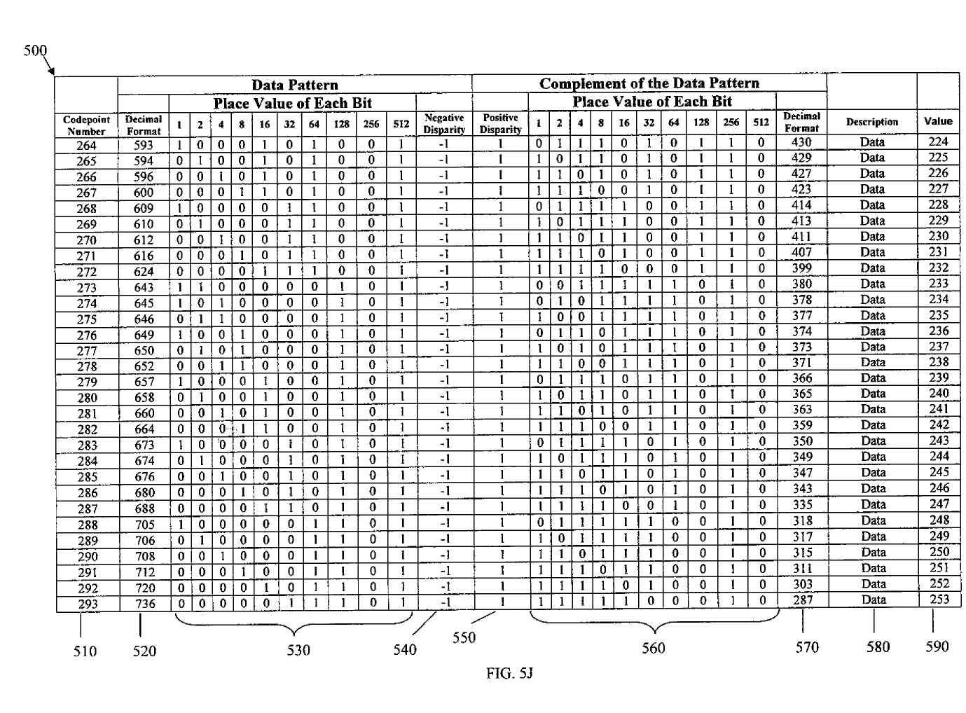

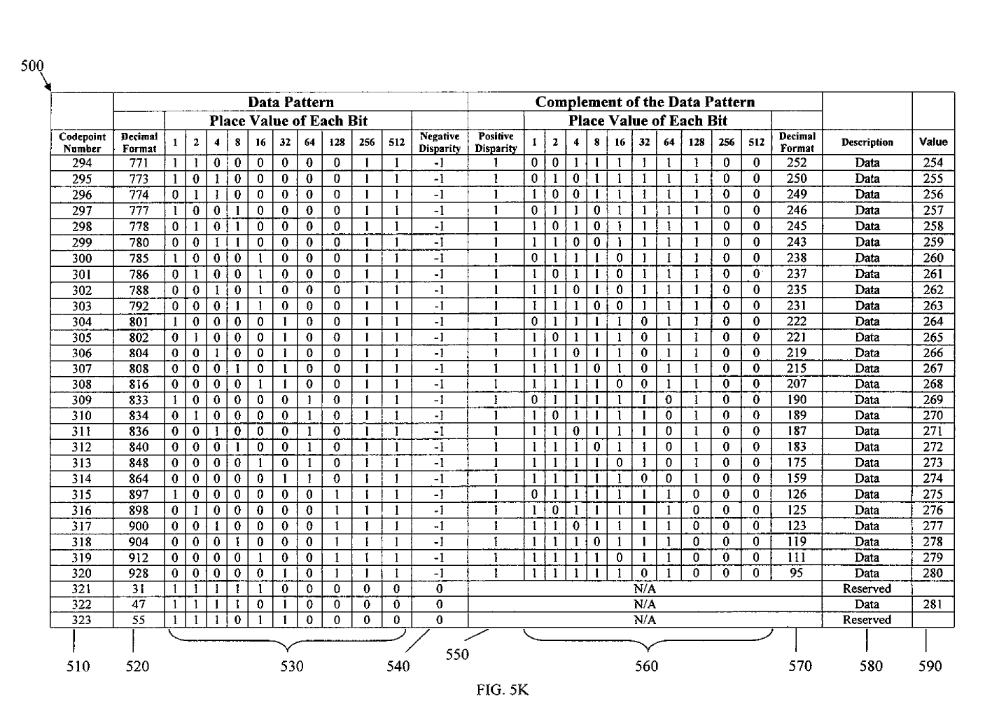

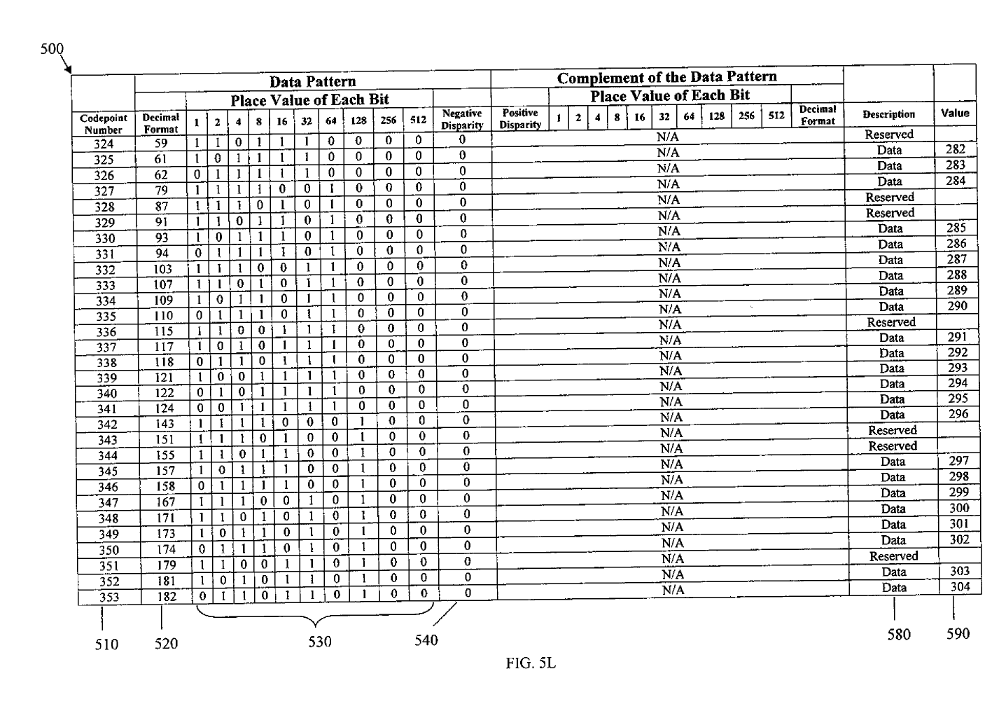

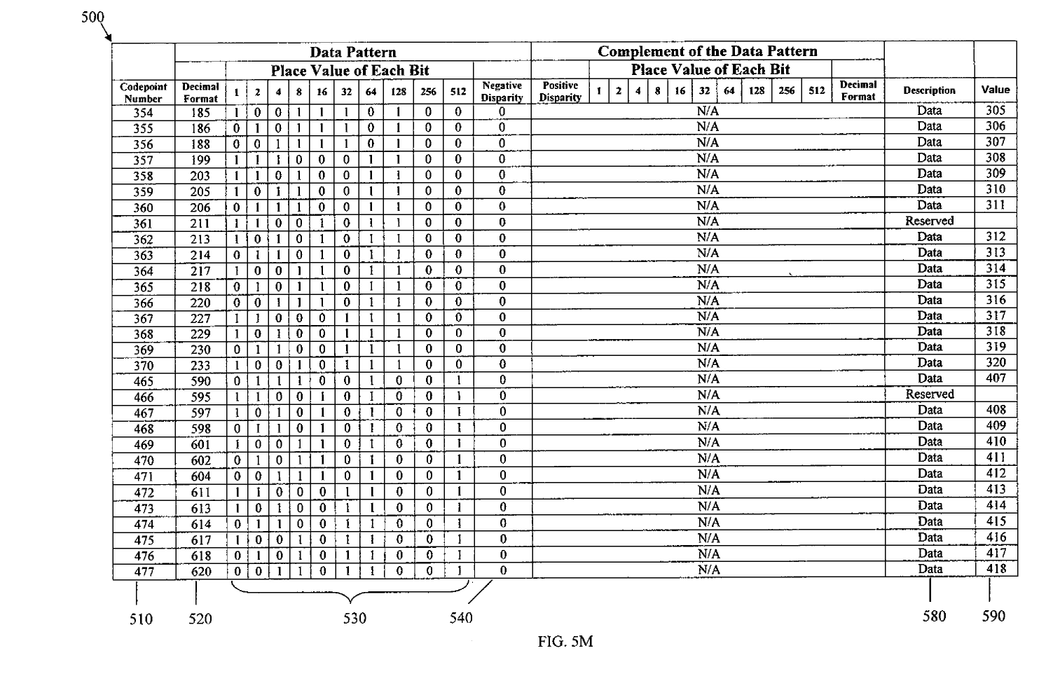

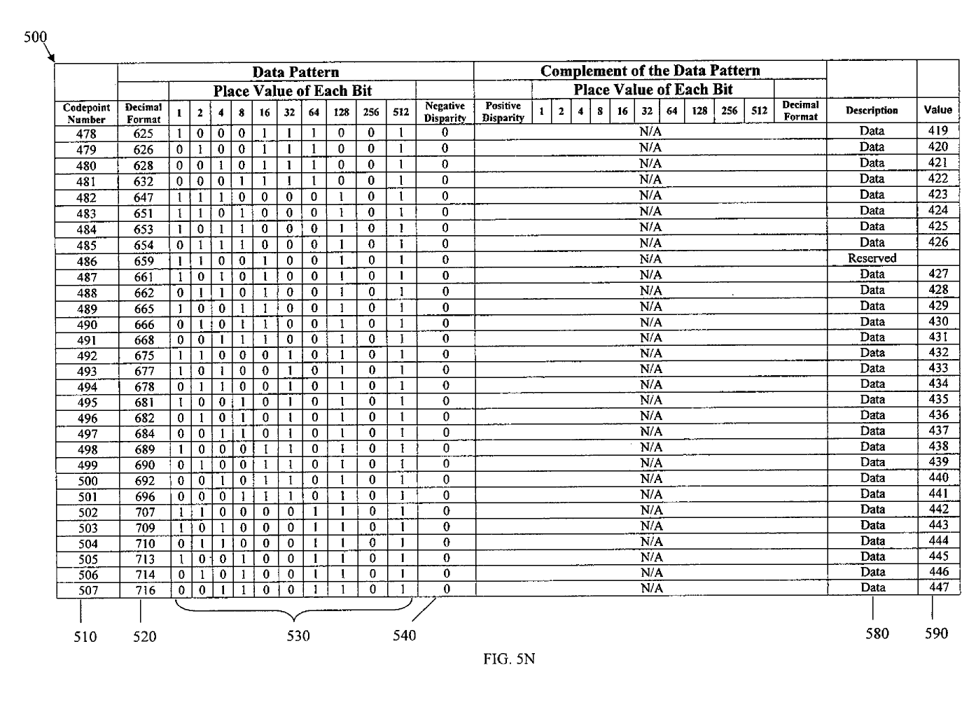

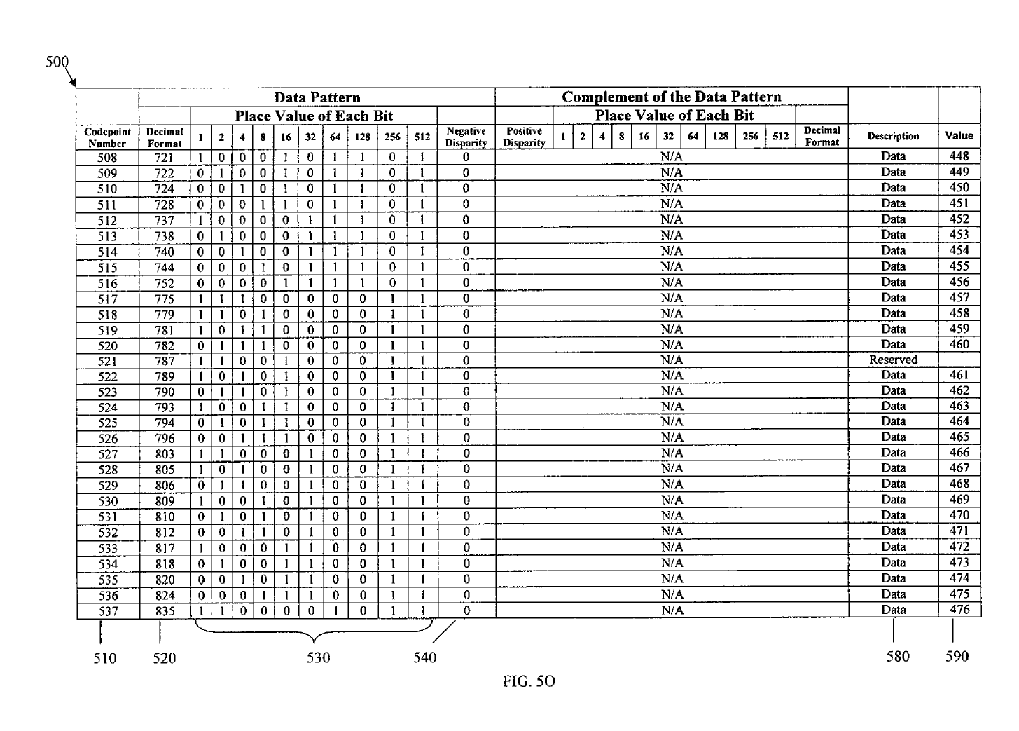

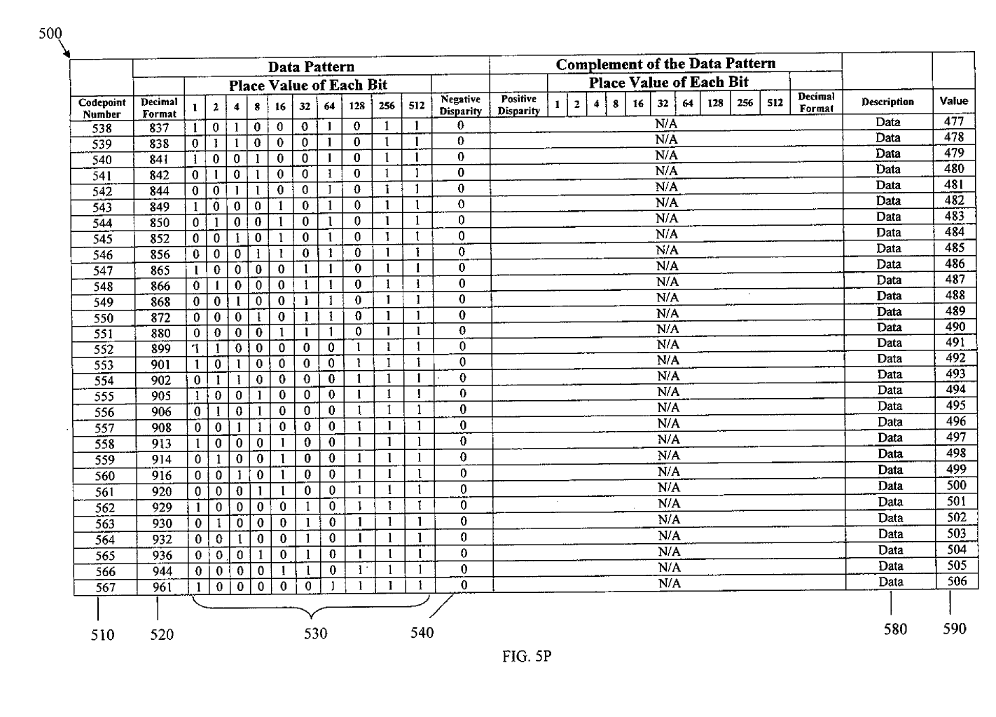

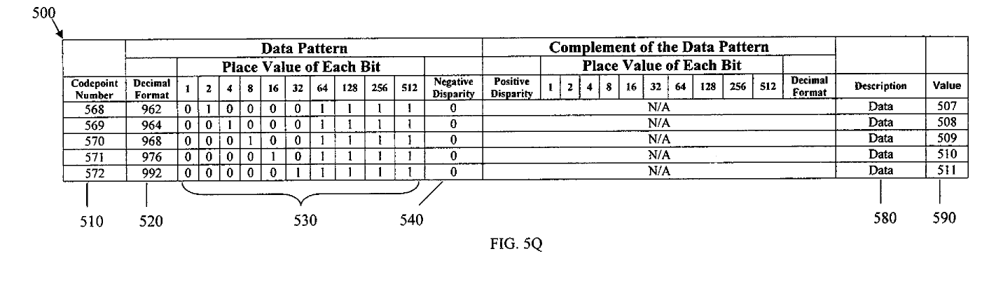

FIGS. 5A-5Q show a table 500 that illustrates an embodiment of the 9b10b code. Each row in the table 500 may correspond to one of the 252 DC balanced codepoints, one of the 208 pairs of complementary codepoints with absolute disparities of one and run-lengths less or equal to five, or one of the 112 pairs of complementary codepoints with absolute disparities equal to two and run-lengths less or equal to five. In the case of the codepoints with negative disparities and the DC balanced codepoints (with disparities equal to zero), the equivalent decimal values, the codepoints, and the corresponding disparities are shown in columns 520, 530 and 540, respectively. The equivalent decimal values for the complementary codepoints (e.g. with positive bit disparity values), the complementary codepoints, and the corresponding disparities are shown in columns 550, 560, and 570, respectively. Moreover, the serial number or count for each codepoint, the description or type of each codepoint, and the assigned user data block value for each codepoint and its complement are shown in columns 510, 580, and 590, respectively.

As shown in FIGS. 5A-5Q, the 9b10b code may comprise 13 control codepoints that may be used as flags or frame delimiters, 512 data codepoints that may map the user data blocks, and 47 reserved codepoints that may not be used. As shown in the first row, the 13 control codepoints may comprise the special codepoint and its complement, which may be assigned a control value of zero. The 13 control codepoints may also comprise the 12 control codepoints, each comprising two complementary patterns, which may be assigned control values ranging from one to 12, as shown in column 590. The 47 reserved codepoints may comprise the seven reserved codepoints from the 208 pairs of complementary codepoints with absolute bit disparity values of one and run-lengths less or equal to five. Each of the seven codepoints may comprise two complementary patterns that may not be transmitted or assigned any values. The 47 reserved codepoints may also comprise 19 of the 40 reserved codepoints (shown in the table 400) with hamming distances of two from the special control codepoint, which may also be part of the 112 pairs of complementary codepoints with absolute bit disparity values equal to two and run-lengths less or equal to five. The 19 codepoints may each comprise two complementary patterns that may not be used in the 9b10b code. The 47 reserved codepoints may also comprise 21 DC balanced codepoints, each comprising a single pattern that may be excluded. The 512 data codepoints may also comprise the remaining 80 codepoints from the 112 pairs of complementary codepoints, and each may comprise two complementary patterns that may be assigned the data block values ranging from zero to 79. The 512 data codepoints may also comprise the remaining 201 codepoints from the 208 pairs of complementary codepoints. Each of the 201 codepoints may comprise two complementary codepoints that may be assigned the data block values ranging from 80 to 280. The 512 data codepoints may comprise the remaining 231 DC balanced codepoints comprising single patterns that may be assigned the data block values ranging from 281 to 511 as shown in column 590.

In other embodiments, the 9b10b code may comprise different numbers of control and reserved codepoints, where the control and reserved codepoints may also comprise different codepoints than those shown in the table 500. For example, the 9b10b code may comprise two different complementary patterns for the special codepoint with no additional control codepoints or alternatively with more than 12 control codepoints and less than 47 reserved codepoints. The 9b10b code may also map the 512 data blocks to a different set of 512 data codepoints. For instance, the 9b10b code may comprise more DC balanced codepoints and less codepoints with absolute bit disparity values equal to one or two. The 9b10b code may also use the same number of DC balanced codepoints and codepoints with higher bit disparity values but may assign each data codepoint to a different data block value. In some embodiments of the 9b10b code, some data codepoints with absolute bit disparity values that may be greater than two, run-lengths that may be greater than five, or both, may be used as control codepoints or to map some of the data blocks.

The 9b10b code may map the nine-bit user data blocks into the ten-bit codepoints without error correction. In such a case, the data blocks may be mapped to the wrong codepoint using the 9b10b code when a bit error occurs in the data blocks. To reduce the possibility of bit errors occurring, a string comprising a plurality of eight-bit data blocks may be converted into a string comprising an equal number of nine-bit codeblocks. The additional bits in the string of codeblocks may be parity bits that may be used for FEC purposes by trading off an increase in the required bandwidth for data transmission. In FEC, the parity bits may be received and used to determine whether bit errors have occurred. The occurring bit errors may then be corrected within certain limits and without requesting the retransmission of data. In an embodiment, the eight-bit data blocks may be converted into the nine-bit codeblocks using a code from a family of Reed Solomon codes referred to as RS(511, 511−X), where X is the number of parity symbols, and may be an integer less than 511. Specifically, the RS(511, 511−X) codes may map a group comprising 511−X of eight-bit data blocks into 511 of eight-bit data codeblocks comprising X additional eight-bit parity blocks. By choosing an RS(511, 511−X) code with an appropriate value of X, the 511 codeblocks may be partitioned into 511−X of nine-bit codeblocks, thus effectively converting the string of eight-bit data blocks into the nine-bit codeblocks. The RS(511, 511−X) codes may have error tolerances that are equal to half of X (X/2), e.g. the RS(511, 511−X) codes may correct the error bits occurring in up to X/2 data blocks.

Since transmission equipment in many communication systems may be configured to handle and transmit eight-bit data blocks, the RS(511, 511−X) code may provide a compatible interface to generate nine-bit data blocks that may then be mapped into the ten-bit codepoints using the 9b10b. For instance, using a SDH-16 standard for data transmissions over optical fibers, the data blocks may be packaged in a string of nine data blocks comprising each eight bits, which may be transmitted using a bandwidth at about 2.5 Gigabits per second (Gb/s). The string of nine data blocks comprising a total number of 72 bits may be converted into a string of nine codeblocks comprising each nine bits using the RS(511, 511−X) code. The string of nine codeblocks comprising a total of 81 bits including the additional parity bits may then be mapped into a string of nine codepoints comprising each ten bits using the 9b10b code. The string of nine codepoints comprising a total of 90 bits may be transmitted using a bandwidth at about 3.125 GB/s, e.g. at about the bandwidth required for transmitting the eight-bit data blocks multiplied by the ratio of ten bits in the codepoints to eight bits in the data blocks.

When using the RS encoding and the 9b10b code, the overhead may be equal to that required by the 8b10b code, e.g. about 25 percent. However, since the codepoints transmitted using the 9b10b code may be less DC balanced and may have longer run-lengths than those transmitted using the 8b10b code, some of the bandwidth required in the case of the 8b10b code may be saved in the case of the 9b10b code. The 9b10b code may use the saved bandwidth to implement the FEC using, for example, the RS(511, 511−X) code which may not be supported in the 8b10b code.

In other embodiments, the string of data blocks that may be mapped into a string of codepoints may be equal to any even number of groups of nine data blocks, which may be less or equal to 56. For example, a string comprising 24 or 30 groups of nine data blocks comprising a total of 1728 or 2160 bits, respectively, may be mapped into 24 or 30 groups of nine codepoints comprising 2160 or 2700 bits, respectively.

Moreover, the groups of nine codepoints may be transmitted in a PON in a manner compatible with the physical layer of the PON. For instance, a PON comprising an L×4 physical layer may use one of four wavelength channels with a bandwidth capability of about 3.125 Gb/s to transmit the string of nine codepoints. Each of the four wavelength channels may also be used to transmit the codepoints upstream to the OLT while implementing FEC to improve the quality of transmission. Using the four wavelength channels of the L×4 physical layer to transmit the 9b10b code may also enable the PON system to reach sufficient transmission quality ten Gb/s bandwidth capability using standard transmission equipment.

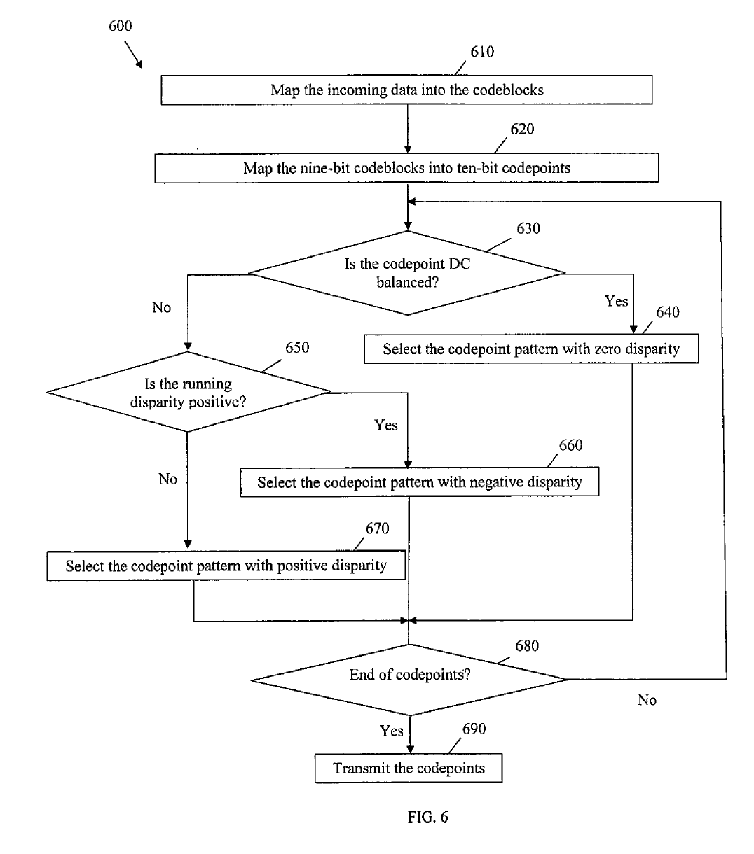

FIG. 6 illustrates an embodiment of a method 600 for implementing the 9b10b code. The method 600 may be implemented at any of the ONTs or the OLT that may transmit data in the PON. At block 610, the method 600 may map the string of user data blocks with eight bits into the string of codeblocks with nine bits, e.g. using the RS(511, 51131 X) code that may add a plurality of parity bits in the string. At block 620, the method 600 may map each codeblocks with nine bits in the string into a corresponding codepoint with ten bits using the 9b10b code. At block 630, the method 600 may determine whether the codepoint in the string is a DC balanced codepoint, e.g. whether the bit disparity value of the mapped codepoint is equal to zero. The method 600 may proceed to block 640 when the condition in block 630 is met. At block 640, the method 600 may assign the single codepoint to the DC balanced codepoint and then proceed to block 680. Otherwise, the method 600 may proceed to block 650.

At block 650, the method 600 may verify whether the running bit disparity for the previously processed codepoints may be positive (equal to one or two). If the running bit disparity is found equal to one or two, the method 600 may proceed to block 660. On the other hand, if the running bit disparity is found equal to negative one or negative two, the method 600 may proceed to block 670. At block 660, the method 600 may assign the pattern with the negative bit disparity value to the codepoint to bind the running bit disparity between negative two and two. The method 600 may also update the running bit disparity value by adding the bit disparity value of the assigned pattern to the running bit disparity value, and then proceed to block 680. Alternatively, at block 670, the method 600 may assign the pattern with the positive bit disparity value to the codepoint, update the running bit disparity value, and proceed to block 680. At block 680, the method 600 may check whether any codepoints remain in the string. If the condition at block 680 is met, the method 600 may proceed to block 630 to assign the appropriate pattern for the next codepoint in the string. Otherwise, the method 600 may proceed to block 690 and transmit the string of codepoints.

In some embodiments, converting the eight-bit data blocks into the nine bits codeblocks at block 610 may be optional or implemented in a separate process from the method 600. For instance, the method 600 may map each generated data block with nine bits into a codepoint with ten bits, update the running bit disparity, and transmit the codepoint before processing the next generated data block. The method 600 may also comprise additional steps that may be implemented when receiving the codepoints at the OLT, or at any of the ONTs. For instance, after transmitting the codepoints at block 690, the method 600 may receive the string of transmitted codepoints and map each codepoint in the string to the corresponding nine-bit value using the 9b10b code.

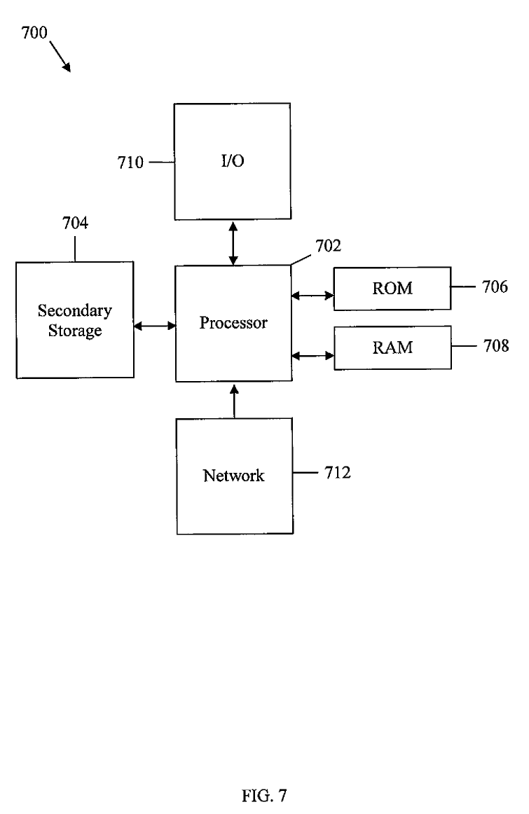

The network described above may be implemented on any general-purpose network component, such as a computer or network component with sufficient processing power, memory resources, and network throughput capability to handle the necessary workload placed upon it. FIG. 7 illustrates a typical, general-purpose network component suitable for implementing one or more embodiments of a node disclosed herein. The network component 700 includes a processor 702 (which may be referred to as a central processor unit or CPU) that is in communication with memory devices including secondary storage 704, read only memory (ROM) 706, random access memory (RAM) 708, input/output (I/O) devices 710, and network connectivity devices 712. The processor may be implemented as one or more CPU chips, or may be part of one or more application specific integrated circuits (ASICs).

The secondary storage 704 is typically comprised of one or more disk drives or tape drives and is used for non-volatile storage of data and as an over-flow data storage device if RAM 708 is not large enough to hold all working data. Secondary storage 704 may be used to store programs that are loaded into RAM 708 when such programs are selected for execution. The ROM 706 is used to store instructions and perhaps data that are read during program execution. ROM 706 is a non-volatile memory device that typically has a small memory capacity relative to the larger memory capacity of secondary storage. The RAM 708 is used to store volatile data and perhaps to store instructions. Access to both ROM 706 and RAM 708 is typically faster than to secondary storage 704.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. An apparatus comprising:
at least one processor configured to implement a method comprising:
receiving an incoming data stream;
converting the incoming data stream into an outgoing data stream comprising a plurality of ten-bit codepoints each comprising nine data bits; and
transmitting the outgoing data stream.

2. The apparatus of claim 1, wherein the incoming data stream comprises a plurality of eight-bit data blocks, and wherein the converting comprises converting the eight-bit data blocks into the nine data bits in the ten-bit codepoints.

3. The apparatus of claim 2, wherein the eight-bit data blocks are converted using a Reed Solomon code.

4. The apparatus of claim 1, wherein the nine data bits comprise parity bits used for forward error correction.

5. The apparatus of claim 1, wherein at least some of the ten-bit codepoints have five one bits and five zero bits.

6. The apparatus of claim 1, wherein each of the ten-bit codepoints has a bit disparity of negative two, negative one, zero, one, or two.

7. The apparatus of claim 6, wherein codepoints with a bit disparity of negative two, negative one, one, or two can be substituted by a complementary codepoint without changing the information in the outgoing data stream.

8. The apparatus of claim 1, wherein none of the ten-bit codepoints have six or more consecutive identical bits.

9. The apparatus of claim 1, wherein one of the ten-bit codepoints is a special control codepoint that is a hamming distance of greater than two away from any other ten-bit codepoint.

10. The apparatus of claim 1, wherein the method further comprises maintaining a running bit disparity of the outgoing data stream.

11. The apparatus of claim 9, wherein the ten-bit codepoint has a negative bit disparity when the running bit disparity is positive, and has a positive bit disparity when the running bit disparity is negative.

12. The apparatus of claim 1, wherein the outgoing data stream is direct current (DC) balanced.

13. An apparatus comprising:
a nine-bit data block/ten-bit codepoint converter;
an optical receiver coupled to the nine-bit data block/ten-bit codepoint converter; and
an optical transmitter coupled to the nine-bit data block I ten-bit codepoint converter.

14. The apparatus of claim 1, wherein the transmitter and the receiver are compatible with an L×4 physical layer.

15. The apparatus of claim 1, wherein the transmitter and the receiver are compatible with Ethernet base-X encoding.

16. A method comprising:
identifying a group comprising a plurality of codepoints each having a common length;
excluding from the group any codepoints with a bit disparity absolute value greater than a first threshold;
excluding from the group any codepoints with a consecutive number of identical bits greater than a second threshold; and
defining a special codepoint within the group that has a hamming distance greater than a third threshold from any other codepoint.

17. The method of claim 16, further comprising mapping any remaining codepoints in the group to a plurality of integer values.

18. The method of claim 17, further comprising configuring the remaining codepoints to accept forward error correction data.

19. The method of claim 16, wherein the first threshold is about two, the second threshold is about five, and the third threshold is about two.

20. The method of claim 16, wherein the length is ten bits and each codepoint comprises nine data bits.
